(19) United States
(12) Patent Application Publication
(10) Pub. No.: US 2025/0027608 A1
(43) Pub. Date: Jan. 23, 2025

(54) SYSTEMS AND METHODS FOR STORING MATERIALS IN EARTHEN SUBTERRANEAN FORMATIONS

(71) Applicant: National Oilwell Varco, L.P., Houston, TX (US)

(72) Inventors: Farzad Azizi, Sugarland, TX (US); Travis James Miller, Cypress, TX (US); Charles Leonard Wright, II, Montgomery, TX (US)

(73) Assignee: National Oilwell Varco, L.P., Houston, TX (US)

(21) Appl. No.: 18/778,506

(22) Filed: Jul. 19, 2024

Related U.S. Application Data
(60) Provisional application No. 63/527,883, filed on Jul. 20, 2023.

(51) Int. Cl. F17C 3/00; F03B 13/06; G21F 9/34

(52) U.S. Cl. CPC F17C 3/005; F03B 13/06; F05B 2260/422; F17C 2221/012; G21F 9/34

(57) ABSTRACT

A system for storing materials in an earthen subterranean formation includes a wellbore extending from a terranean surface into the subterranean formation, the wellbore extending from an uphole end at the terranean surface to a longitudinally opposing downhole end, a casing string extending through the wellbore, wherein the casing string is cemented in place in the wellbore, a subterranean storage chamber formed in a salt deposit of the subterranean formation and fluidically connected to the wellbore, the storage chamber at least partially filled with brine and having a lateral width that exceeds a vertical height of the storage chamber, wellbore-transportable foreign material that is stored in the storage chamber.

### CROSS-REFERENCE TO RELATED APPLICATIONS

The present application claims benefit of U.S. provisional patent application No. 63/527,883 filed Jul. 20, 2023, entitled “Systems and Methods for Storing Materials in Earthen Subterranean Formations”, which is incorporated herein in its entirety for all purposes.

### STATEMENT REGARDING FEDERALLY SPONSORED RESEARCH OR DEVELOPMENT

Not applicable.

### BACKGROUND

Earthen subterranean formations have been used to store various foreign materials (e.g., materials that have been artificially delivered or injected into the subterranean formation) in manifold applications. As one example, hydrocarbons such as natural gas are routinely stored in subterranean formations. In some instances, natural gas is conveniently stored in voids formed within subterranean salt deposits sometimes referred to as “salt caverns.” The salt cavern may be formed through a process referred to as “solution mining” in which water is pumped into the salt deposit to dissolve the salt thereof forming a void in the salt deposit. The resulting brine formed from contact between the pumped water and the salt of the salt deposit may be recirculated to the surface. Such salt caverns formed through solution mining typically have a vertical height significantly greater than their lateral width to maximize storage capacity of the hydrocarbons (e.g., natural gas) to be stored therein. Another example of subterranean formations used for storing foreign materials pertains to the storage of nuclear waste generated by nuclear facilities (e.g., nuclear power plants). A further example of subterranean formations used for storing foreign materials pertains to fluids utilized in pumped hydroelectricity energy storage (PHES) systems (sometimes also referred to as pumped-storage hydroelectricity (PSH) systems).

### SUMMARY

An embodiment of a system for storing materials in an earthen subterranean formation comprises a wellbore extending from a terranean surface into the subterranean formation, the wellbore extending from an uphole end at the terranean surface to a longitudinally opposing downhole end, a casing string extending through the wellbore, wherein the casing string is cemented in place in the wellbore, a subterranean storage chamber formed in a salt deposit of the subterranean formation and fluidically connected to the wellbore, the storage chamber at least partially filled with brine and having a lateral width that exceeds a vertical height of the storage chamber, and wellbore-transportable foreign material that is stored in the storage chamber. In some embodiments, a ratio of the lateral width of the storage chamber to the vertical height of the storage chamber is equal to or greater than 2:1. In some embodiments, a ratio of the lateral width of the storage chamber to the vertical height of the storage chamber is equal to or greater than 4:1. In certain embodiments, a ratio of the lateral width of the storage chamber to the vertical height of the storage chamber is equal to or greater than 10:1. In certain embodiments, a ratio of a surface area to a volume of the storage chamber is equal to or greater than 5:1. In some embodiments, the system comprises one or more storage containers positioned in the storage chamber, the one or more storage containers each comprising an inner cavity holding at least some of the stored material. In some embodiments, the stored material comprises the brine at least partially filling the storage chamber. In certain embodiments, the stored material comprises hydrogen. In certain embodiments, the storage chamber comprises a single opening, the single opening fluidically connected to the wellbore. In some embodiments, the stored material comprises radioactive waste material. In some embodiments, the storage chamber is defined by a vertically lower floor formed from at least one of limestone, shale, and red rock of the subterranean formation. An embodiment of a pumped hydroelectricity energy storage system comprises a first reservoir located along the terranean surface, a second reservoir located at least partially within the storage chamber, the second reservoir in fluid communication with the first reservoir, and a pump fluidically connected to both the first reservoir and the second reservoir and configured to pump at least some of the brine into the second reservoir from the direction of the first reservoir.

An embodiment of a method for storing materials in an earthen subterranean formation comprises (a) forming a wellbore extending vertically from a terranean surface into the subterranean formation, the wellbore extending from an uphole end at the terranean surface to a longitudinally opposing downhole end, (b) installing a casing string in the wellbore whereby the casing string is cemented in place in the wellbore, (c) installing tubing within a central passage of the casing string whereby an annulus is formed between the casing string and the tubing, (d) injecting a solvent from the terranean surface into the wellbore through a central passage of the tubing, and (e) circulating salt from the wellbore to the terranean surface through the annulus in response to (d) to form a subterranean storage chamber in a salt deposit of the subterranean formation that is fluidically connected to the wellbore, the storage chamber at least partially filled with brine and having a lateral width that exceeds a vertical height of the storage chamber. In certain embodiments, the method comprises (f) injecting a protective fluid from the terranean surface into the wellbore to form a protective blanket of the protective fluid over a surface of the solvent contained in the storage chamber thereby preventing contact between the solvent and the casing string. In certain embodiments, the protective fluid has a lower specific gravity than the solvent. In some embodiments, a ratio of the lateral width of the storage chamber to the vertical height of the storage chamber is equal to or greater than 2:1. In some embodiments, a ratio of a surface area to a volume of the storage chamber is equal to or greater than 5:1.

An embodiment of a method for storing materials in an earthen subterranean formation comprises (a) forming a wellbore extending vertically from a terranean surface into the subterranean formation, the wellbore extending from an uphole end at the terranean surface to a longitudinally opposing downhole end, (b) installing a casing string in the wellbore whereby the casing string is cemented in place in the wellbore, (c) installing an outer tubing within a central passage of the casing string whereby an outer annulus is formed between the casing string and the outer tubing, (d) installing an inner tubing within a central passage of the outer tubing whereby an inner annulus is formed between the outer tubing and the inner tubing, (e) injecting a solvent from the terranean surface into the wellbore through a central passage of the inner tubing, (f) circulating salt from the wellbore to the terranean surface through the inner annulus in response to (d) to form a subterranean storage chamber in a salt deposit of the subterranean formation that is fluidically connected to the wellbore, the storage chamber being at least partially filled with brine, (g) injecting a protective fluid from the terranean surface into the wellbore through the outer annulus to form a protective blanket of the protective fluid over a surface of the solvent contained in the storage chamber thereby preventing contact between the brine and the casing string, and (h) controlling a ratio of a volume of the solvent and a volume of the protective fluid injected into the wellbore to form the storage chamber with a predefined form factor. In certain embodiments, the form factor of the storage chamber is defined by a lateral width and a vertical height, the lateral width exceeding the vertical height of the storage chamber. In certain embodiments, a ratio of the lateral width of the storage chamber to the vertical height of the storage chamber is equal to or greater than 2:1. In certain embodiments, (h) comprises (h1) decreasing the ratio of the volume of the solvent and the volume of the protective fluid to increase a lateral width of the storage chamber relative to a vertical height of the storage chamber.

### BRIEF DESCRIPTION OF THE DRAWINGS

For a detailed description of disclosed exemplary embodiments, reference will now be made to the accompanying drawings in which:

FIG. 1 is a schematic diagram of an exemplary embodiment of a subterranean storage system in accordance with principles disclosed herein;

FIG. 2 is a schematic diagram of another exemplary embodiment of a subterranean storage system in accordance with principles disclosed herein;

FIG. 3 is a schematic diagram of an exemplary embodiment of an energy storage system in accordance with principles disclosed herein;

FIGS. 4-7 are schematic diagrams of an exemplary method for forming a subterranean storage chamber in accordance with principles disclosed herein

FIG. 8 is a block diagram of an embodiment of a computer system in accordance with principles disclosed herein;

FIG. 9 is a flowchart of an embodiment of a method for storing materials in an earthen subterranean formation in accordance with principles disclosed herein; and

FIG. 10 is a flowchart of another embodiment of a method for storing materials in an earthen subterranean formation in accordance with principles disclosed herein.

### DETAILED DESCRIPTION

The following discussion is directed to various embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection as accomplished via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Any reference to up or down in the description and the claims is made for purposes of clarity, with “up”, “upper”, “upwardly”, “uphole”, or “upstream” meaning toward the surface of the borehole and with “down”, “lower”, “downwardly”, “downhole”, or “downstream” meaning toward the terminal end of the borehole, regardless of the borehole orientation.

As described above, subterranean formations have been used to store various foreign materials in manifold applications. As used herein, the term “foreign material” refers to materials that have been artificially delivered or injected into the subterranean formation. Beyond the storage of hydrocarbons as discussed briefly above, subterranean formations are also used to store other materials such as materials utilized in energy generation and storage systems. For example, nuclear waste generated by nuclear power generation systems has typically been stored in subterranean formations, typically within tunnels formed within natural elevations such as mountains and the like. Similarly, subterranean formations located within natural elevations have been utilized in energy generation and storage systems which utilize gravitational potential energy such as, for example, PHES systems.

Safe storage of nuclear waste from energy generation and other nuclear systems as well as materials (e.g., high-pressure brine, produced hydrogen) utilized in energy storage systems (e.g., PSH and other systems leveraging gravitational potential energy) has long been a limiting factor in advancing renewable energy sources. Particularly, over the past several decades, numerous attempts have been made at finding a suitable solution for storing nuclear waste and other materials utilized in power generation and storage systems (e.g., high-pressure brine, hydrogen) in a safe, cost effective, and environmentally friendly manner, including storing such materials in subterranean formations as outlined above.

With respect to nuclear waste, conventional waste storage methods have emphasized the use of tunnels as is exemplified by the design of the Yucca mountain storage facility. Other techniques include large laterally extending wellbores (e.g., wellbores extending laterally hundreds or thousands of feet through a subterranean formation) drilled into a subterranean formation. However, due to the large lateral distances involved with storing foreign materials in lateral wellbores, the costs associated with forming such large lateral wellbores, as well as the costs of monitoring the foreign materials when installed into the wellbore, are substantial and thus limiting on the utilization of subterranean formation for storing such foreign materials

Further, with respect to other energy generation and storage systems, a major limiting factor in the expansion of solar and wind power is lack of cost-effective energy storage such as PSH systems. Typically, PSH systems are geographically limited as two large sources of water at two different altitude is needed. Earlier methods attempted to resolve this issue by forming fractures in non-permeable subterranean formations such that pressurized foreign materials could then be stored in the formed fractures and cyclically discharged to a surface reservoir. However, such fractures in non-permeable subterranean formations are generally not self-healing (e.g., the fractures degrade over time) and have the tendency to grow unpredictably under cyclic load. For these reasons, the seal life of such fractures is limited, thus limiting the operational life of energy generation and storage systems utilizing such fractures for the storage of foreign materials.

Accordingly, embodiments of systems and methods for storing materials (e.g., foreign materials) in earthen subterranean formations is disclosed herein. In an embodiment, a subterranean storage system includes a wellbore extending vertically from a terranean surface into the subterranean formation, the wellbore extending from an uphole end at the terranean surface to a longitudinally opposing downhole end, and a casing string extending through the wellbore, wherein the casing string is cemented in place in the wellbore. Additionally, the subterranean storage system includes a subterranean storage chamber formed in a salt deposit of the subterranean formation and fluidically connected to the wellbore, the storage chamber at least partially filled with brine and having a lateral width that exceeds a vertical height of the storage chamber, where wellbore-transportable foreign materials are stored in the storage chamber. For example, hazardous foreign materials such as nuclear waste may be stored in the storage chamber. Alternatively, or in addition, materials utilized in power generation and/or storage systems may be stored in the storage chamber including, for example, pressurized brine and hydrogen.

The storage chamber of embodiments of subterranean storage systems disclosed herein have a form factor which differs from conventional salt caverns and which is uniquely suitable and advantageous for the storage of both hazardous foreign materials as well as foreign materials used in energy generation and/or storage systems including, for example, PSH systems. Particularly, embodiments of storage chambers disclosed herein have a greater lateral width than a vertical height such that the storage chamber is, for example, provided with a thin, disc shape. As used herein, the terms “lateral width” and “vertical height” are in reference to the direction of gravity with the “lateral” direction extending orthogonal the direction of gravity and the “vertical” direction extending parallel the direction of gravity. Additionally, storage chambers having a form factor with a greater lateral width than a vertical height thereof are generally referred to herein as “thin form factors.”

The thin, disc or pancake shape of the storage chamber provides for more convenient storage of foreign materials including hazardous foreign materials and foreign materials utilized in energy generation and/or storage systems. For example, some hazardous foreign materials such as nuclear waste cannot be stored in relatively dense layouts or configurations and instead must be spread out across a relatively long or wide storage area or chamber. For instance, nuclear waste generates heat and thus must be spread out to avoid overheating portions of the subterranean formation which could damage the storage chamber and/or other components of the subterranean storage system. By storing nuclear waste in a wide but short (e.g., having a relatively small vertical height) storage chamber the nuclear waste can be spread out within a storage chamber having a limited volume (and thus being easier to form in situ). Additionally, a thin disc shape permits the spreading out of the nuclear waste without needing to utilize elongate lateral wellbores or tunnels which must extend laterally across large distances in order to provide the same surface area for storing an equivalent quantity of nuclear waste, with such large lateral distances significantly increasing the costs for both constructing said lateral wellbores/tunnels and monitoring the nuclear waste (e.g., monitoring systems must extend across the large lateral distances of the lateral wellbore/tunnel) once it has been stored therein.

Further, the thin form factors of embodiments of storage chambers disclosed herein are also uniquely advantageous for at least some energy generation and/or storage systems. For example, as described above, PHES systems rely on cycling materials between a first elevation and a second elevation in order to utilize gravitational potential energy for energy storage. The thin form factor of embodiments of storage chambers described herein are generally more efficient than other, conventional form factors (e.g., spheroid) in that they permit greater stored hydraulic energy (e.g., akin to a stiff spring having short travel) in order to cycle the material between the different elevations (with the storage chamber providing the lower of the two elevations). Thus, PHES systems employing embodiments of storage chambers disclosed herein may be more energy efficient (along with potentially being less expensive to form) than conventional PHES systems because the thin form factor of the storage chamber allows for fluid pressure within the storage chamber to be increased slightly in response to adding a relatively large volume of fluid to the storage chamber (opposite of conventional salt caverns). Particularly, the thin form factor of the storage chamber forms a relatively large, disc-shaped roof of the storage chamber against which fluid pressure within the storage chamber acts. The large disc-shaped roof acts as a diaphragm that flexes against the subterranean formation in response to changes in fluid pressure within the subterranean chamber, maximizing the amount of energy storable in the subterranean chamber. Additionally, given that embodiments disclosed herein are not geographically limited to relatively high-altitude locations (e.g., high-altitude body reservoir or river), embodiments of PHES systems disclosed herein allow for co-location of the storage chamber and the energy source unlike in conventional PHES systems.

In addition to embodiments of subterranean storage systems, embodiments of methods for storing materials in earthen subterranean formations are also described herein. In an embodiment, a method includes forming a wellbore extending vertically from a terranean surface into the subterranean formation, the wellbore extending from an uphole end at the terranean surface to a longitudinally opposing downhole end, and installing a casing string in the wellbore whereby the casing string is cemented in place in the wellbore. In some embodiments, the method includes installing tubing within a central passage of the casing string whereby an annulus is formed between the casing string and the tubing, and injecting a solvent from the terranean surface into the wellbore through a central passage of the tubing. In certain embodiments, the method additionally includes circulating brine from the wellbore to the terranean surface through the annulus in response to injecting the solvent into the wellbore to form a subterranean storage chamber in a salt deposit of the subterranean formation and fluidically connected to the wellbore, the storage chamber at least partially filled with brine and having a lateral width that exceeds a vertical height of the storage chamber. This method and other methods disclosed herein provide convenient and inexpensive techniques for forming subterranean storage chambers having form factors (e.g., a lateral width greater than a vertical height) uniquely and advantageously suitable for storing hazardous foreign materials as well as foreign materials utilized in at least some energy generation and/or storage systems.

In some embodiments, the method includes injecting a protective fluid (for example, oil based fluid, inert gases such as Nitrogen) from the terranean surface into the wellbore to form a protective blanket of the protective fluid over the surface of the solvent contained in the storage chamber thereby preventing contact between the brine and the casing string, and controlling a ratio of a volume of the solvent and a volume of the protective fluid injected into the wellbore to form the storage chamber with a predefined form factor. Thus, methods disclosed herein may include controlling the ratio of the solvent and protective fluid injected into the wellbore as a means for conveniently and efficiently controlling the form factor of the subterranean storage chamber. In this manner, thin form factors particularly suitable for storing hazardous foreign materials (e.g., nuclear waste) and materials utilized in energy generation and/or storage systems may be conveniently and inexpensively formed.

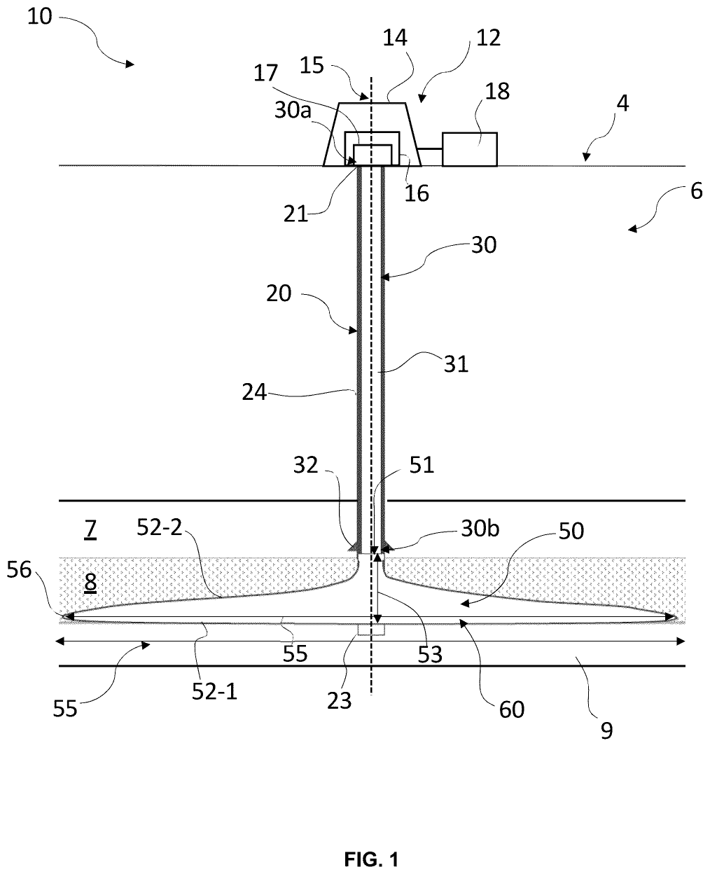

Referring now to FIG. 1, an exemplary embodiment of a system 10 for storing materials in an earthen subterranean formation 6 is shown. In this exemplary embodiment, storage system 10 generally includes equipment 12 disposed at a terranean surface 4 of the subterranean formation 6 (equipment 12 may thus be referred to herein as “surface equipment”), a wellbore 20 extending generally vertically from the terranean surface 4 into the subterranean formation 6, a casing string 30 positioned in the wellbore 20, and a subterranean storage chamber 50 fluidically coupled to the wellbore 20.

Initially, it should be appreciated that the terranean surface 4 may be a land surface, a sub-sea surface (e.g., a seabed), or other underwater surface. Additionally, as will be discussed further herein, subterranean formation 6 comprises a plurality of discrete subterranean layers and sub-layers (such as cap rock layer, salt rock layer, bed rock). Subterranean storage system 10 may be used to store various foreign materials such as, for example, brine, hydrogen, hydrocarbons and hazardous foreign materials (e.g., nuclear waste) within the subterranean formation 6 for extended periods of time (e.g., decades or longer), as will also be discussed further herein.

In general, surface equipment 12 of subterranean storage system 10 may include any suitable equipment for supporting or facilitating transportation of fluids, tools, and/or foreign materials in and out of the wellbore 20. In this exemplary embodiment, surface equipment 12 includes a support structure 14 (e.g., a well head, a casing string head) pressure control equipment 16 (e.g., one or more blowout preventers), surface valving 17 (e.g., one or more choke valves, one or more control valves) for controlling the flow rate of fluids into and from wellbore 20, and one or more surface pumps 18 (e.g., one or more reciprocating pumps, one or more rotary pumps) for pumping fluids into and from wellbore 20.

As shown in FIG. 1, subterranean formation 6 comprises a plurality of discrete layers stacked on top of one another. Particularly, subterranean formation 6 includes, among other features (e.g., other layers) a first or vertically upper impermeable rock layer 7, a salt rock layer 8 (also referred to herein as a “salt deposit” 8), and a second or vertically lower impermeable rock layer 9. In some embodiments, upper impermeable rock layer comprises a cap rock layer (for example, granite) while the lower impermeable rock layer 9 comprises a limestone layer 9. Layers 7, 8, and 9 are vertically stacked such that upper impermeable rock layer 7 is generally positioned vertically above both the salt rock layer 8 and lower impermeable rock layer 9, while the salt rock layer 8 is generally positioned vertically above the lower impermeable rock layer 9. While the interfaces between layers 7, 8, and 9 are shown as extending laterally in FIG. 1, it may be understood that the interfaces between layers 7, 8, and 9 may include various folds and other irregularities. Additionally, it may be understood that the configuration of subterranean formation 6 may vary in other embodiments from that shown in FIG. 1.

Wellbore 20 of subterranean storage system 10 extends vertically from an uphole end 21 located at terranean surface 4, into the subterranean formation 6 along a central or longitudinal axis 15, and to a downhole end 23 located within subterranean formation 6. In this configuration, wellbore 20 provides access to the subterranean storage chamber 50 in the subterranean formation 6. In this exemplary embodiment, wellbore 20 penetrates into the lower impermeable rock layer 9 with the downhole end 23 of wellbore 20 located proximal to (but beneath) the interface formed between lower impermeable rock layer 9 and the salt rock layer 8 of subterranean formation 6. In other embodiments, the downhole end 23 of wellbore 20 may be located within the salt rock layer 8 of subterranean formation 6.

While wellbore 20 is shown in FIG. 1 as substantially vertical, it should be appreciated that in other embodiments wellbore 20 may be deviated and extend at an incline relative to the direction of gravity along one or more sections of the deviated wellbore. Additionally, wellbore 20 may be formed with various dimensions (diameter) and depths. It may also be understood that wellbore 20 is formed using a drilling system not shown in FIG. 1 which may include, among other things, a support structure (e.g., a derrick, a mast) located at the terranean surface 4, and a drilling assembly deployable into the subterranean formation 6 including a drill bit for cutting into the subterranean formation and which is coupled to a downhole end of a drill string suspended from the surface support structure.

Casing string 30 of subterranean storage system 10 extends axially from a first or uphole end 30a located at or proximate to terranean surface 4 (e.g. from surface equipment 12), into wellbore 20, and to a second or downhole end 30b located vertically uphole from the downhole end 23 of wellbore 20. In this exemplary embodiment, the downhole end of casing string 30 is defined by a bottom casing string shoe 32 that is located within the upper impermeable rock layer 7. Casing string 30 provides structural support to wellbore 20 while controlling the communication of formation fluids from subterranean formation 6 to a central passage 31 of casing string 30. Particularly, casing string 30 is secured to a generally cylindrical sidewall 24 of wellbore 20 via cement (or any other suitable material that has been pumped into the annulus formed between an outer surface of casing string 30 and the sidewall 24 of wellbore 20. In this configuration, the central passage 31 of casing string 30 is sealed from the sidewall 24 (which is permeable at some depths of subterranean formation 6) of wellbore 20. In some embodiments, casing string 30 may comprise a plurality of steel casing string joints that are coupled end-to-end and installed in the wellbore 20 via a drilling system not shown in FIG. 1.

Subterranean storage chamber 50 of subterranean storage system 10 is formed in the salt rock layer 8 of subterranean formation 6, and extends between a vertically upper end defined by a central opening 51, and a vertically lower end defined by a floor 52-1 of the storage chamber 50. Storage chamber 50 may overlap at least a portion of the wellbore 20 (e.g., the same volume of space within subterranean formation 6 may correspond to both the wellbore 20 and storage chamber 50) such as the portion of wellbore 20 located proximal the downhole end 23 thereof. Additionally, storage chamber 50 defines a vertically upper ceiling 52-2 positioned opposite the floor 52-1 of storage chamber 50. In this exemplary embodiment, the storage chamber 50 includes only the single opening 51 connected to the wellbore 20. Additionally, in this exemplary embodiment, storage chamber 50 is filled at least partially with brine which may be delivered to the storage chamber 50 via surface equipment 12 and wellbore 20. Each of the layers 7, 8, and 9 have a low fluid permeability, thereby inhibiting fluid within storage chamber 50 (e.g., brine or other fluids) from escaping into the surrounding subterranean formation 6. Further, one or more foreign materials 60 are stored in storage chamber 50 for long term storage. Foreign materials 60 may comprise one or more fluids, and/or one or more solid objects. The self-healing nature of salt rock layer 8 permits the foreign materials 60 to be stored in the storage chamber 50 for large amounts of time (e.g., decades or longer). To state in other words, unlike subsurface fractures (e.g., fractures formed in subsurface layers other than salt rock layers) which degrade and expand unpredictably over time, the salt rock comprising salt rock layer 8 exhibits self-healing characteristics which prevent fractures and other irregularities from expanding over time that could otherwise jeopardize the physical integrity of storage chamber 50. Not intending to be bound by any particular theory, the self-healing nature of damaged salt rock pertains to the recrystallization of rock salt crystals as a result of the migration of existing grain boundaries and the formation of new angle grain boundaries as a result of the damaged salt rock being subjected to high pressures and temperatures (e.g., high pressures and temperatures experienced in subterranean formations).

Central opening 51 of storage chamber 50 is connected to wellbore 20 whereby storage chamber 50 is fluidically connected to wellbore 20. Thus, in this exemplary embodiment, central opening 51 is located proximal the interface formed between upper impermeable rock layer 7 and the salt rock layer 8. Additionally, the floor 52-1 of storage chamber 50 is located at a desired depth within subterranean formation 6 that is deeper than the depth at which the casing string shoe 32 of casing string 30 is located. Particularly, in this exemplary embodiment, the floor 52-1 is positioned generally along the interface formed between the salt rock layer 8 and the lower impermeable rock layer 9 of the subterranean formation 6 such that the floor 52-1 of storage chamber 50 is at least partially defined by the lower impermeable rock layer 9.

The storage chamber 50 has a thin form factor making it uniquely useful for storing foreign materials such as hazardous foreign materials and at least some foreign materials used in energy generation and storage systems (e.g., PSH systems). Particularly, storage chamber 50 has a vertical height 53 extending between the floor 52-1 of storage chamber 50 and the central opening 51 thereof, and a lateral width 55 extending between an outer periphery 56 of the storage chamber 50, where the lateral width 55 exceeds the vertical height 53 of the storage chamber 50. In some embodiments, a ratio of the lateral width 55 to the vertical height 53 of storage chamber is equal to or greater than 2:1. In some embodiments, a ratio of the lateral width 55 to the vertical height 53 of storage chamber is equal to or greater than 4:1. In some embodiments, a ratio of the lateral width 55 to the vertical height 53 of storage chamber is equal to or greater than 10:1. In certain embodiments, a ratio of the lateral width 55 to the vertical height 53 of storage chamber is equal to or greater than 50:1. In certain embodiments, a ratio of the lateral width 55 to the vertical height 53 of storage chamber is equal to or greater than 100:1. In certain embodiments, a ratio of the lateral width 55 to the vertical height 53 of storage chamber is equal to or greater than 500:1.

In addition to having a lateral width 55 that exceeds the vertical height 53 of the storage chamber 50, the thin form factor of storage chamber 50 also provides storage chamber 50 with a relatively great surface area to volume ratio which may also be uniquely advantageous for some applications such as storing some hazardous foreign materials and/or materials utilized in at least some energy generation and/or storage systems. For example, in some embodiments, the ratio of the surface area to the volume of storage chamber is equal to or greater than 5:1. In some embodiments, the ratio of the surface area to the volume of storage chamber is equal to or greater than 10:1. In some embodiments, the ratio of the surface area to the volume of storage chamber is equal to or greater than 15:1. In certain embodiments, the ratio of the surface area to the volume of storage chamber is equal to or greater than 20:1. In certain embodiments, the ratio of the surface area to the volume of storage chamber is equal to or greater than 25:1.

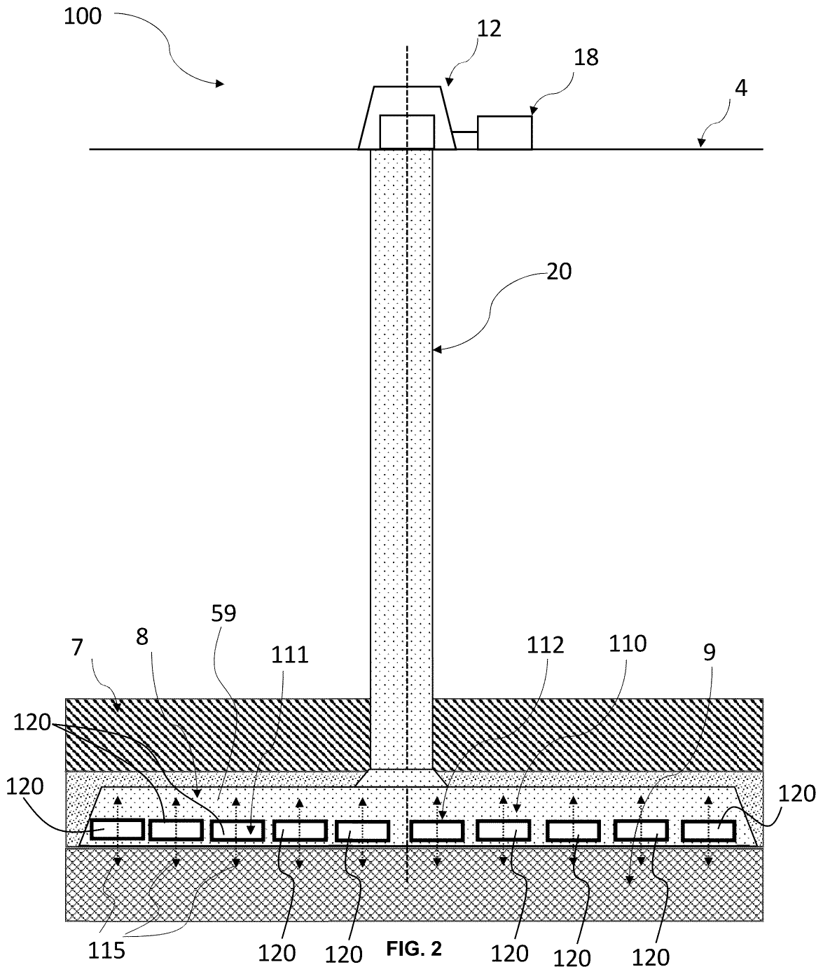

Referring now to FIG. 2, another exemplary embodiment of a subterranean storage system 100 is shown. Storage system 100 includes features in common with storage system 10 shown in FIG. 1, and shared features are labeled similarly. In this exemplary embodiment, subterranean storage system 100 is generally configured for storing hazardous foreign materials such as nuclear waste is shown. Particularly, in this exemplary embodiment, the storage system 100 includes one or more storage containers 110 positioned in the storage chamber 50 (e.g., along the floor 52-1 of storage chamber 50) which is filled with saturated brine 59. Each of the storage containers 110 is defined by an outer housing comprising a sealed inner cavity 111 containing hazardous material 120.

In this exemplary embodiment, the hazardous foreign material 120 contained within storage containers 110 comprises radioactive material (e.g., nuclear waste) which continuously radiate heat (indicated generally by numeral 112 in FIG. 2). In this exemplary embodiment, the downhole end 23 of wellbore 20 may be located several thousand feet (e.g., 2,500 feet or more) below the terranean surface 4 in view of the radioactivity of hazardous material 120. Storage containers 110 are configured to withstand the heat 112 radiating from hazardous foreign material 120. The thin form factor of storage chamber 50 allows for the positioning of a large number of storage containers 110 in a single layer along the floor 52-1 thereof. In this configuration, the storage containers 110 may be spread or spaced apart along the floor 52-1 of storage chamber 50 such that the heat generated by the plurality of storage containers 110 may be adequately spread out across the storage chamber 50 whereby the heat generated by storage containers 110 may not damage portions of the storage chamber 50, and to geothermally keep the hazardous material 120 below its safe temperature. In other words, instead of concentrating the heat (e.g., as a hot spot) generated by storage containers 110 in a single location, as would potentially be the result of storage chambers lacking a thin form factor, the thin form factor of storage chamber 50 serves to distribute the heat across substantially the entire surface area of storage chamber 50.

Further, the thin form factor of storage chamber 50 permits distributing the heat generated by storage containers 110 across a relatively large surface area without relying on an elongate lateral wellbore or tunnel (which would potentially need to be traversed by monitoring equipment) for providing such heat distribution. Instead, the entire volume of storage chamber 50 may be conveniently accessed from the central opening 51 thereof such that the storage containers 110 may be conveniently monitored via monitoring equipment positioned in storage chamber 50.

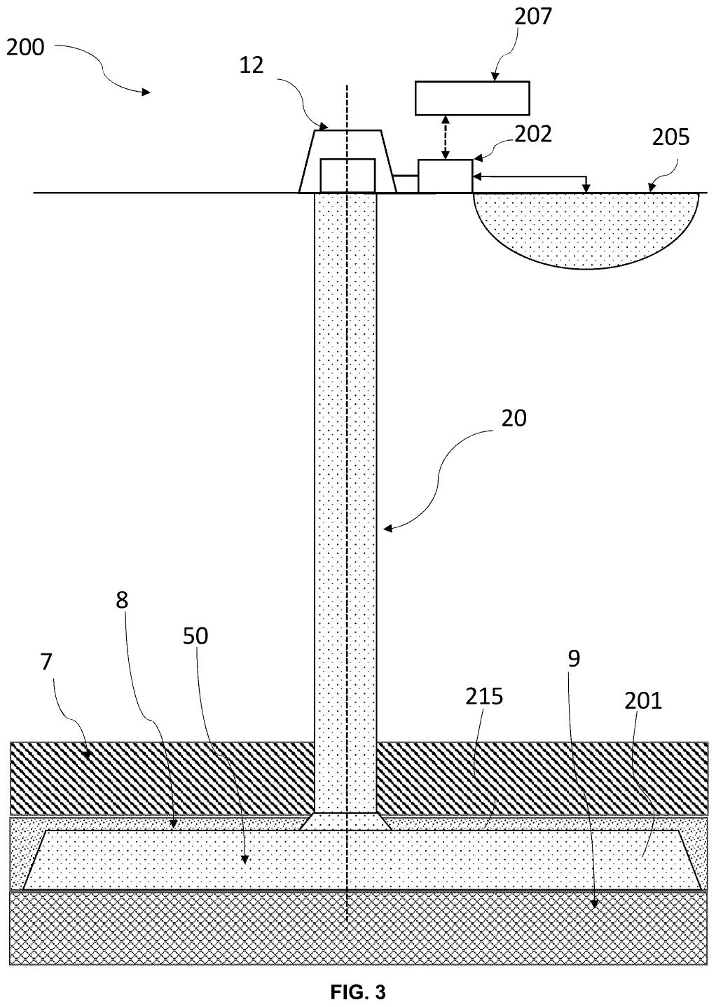

Referring to FIG. 3, an exemplary embodiment of an energy storage system 200 is shown. Energy storage system 200 incorporates features of the subterranean storage system 10 shown in FIG. 1, and shared features are labeled similarly. In this exemplary embodiment, energy storage system 200 is used in PHES applications and thus may also be referred to herein as PHES system 200.

In this exemplary embodiment, energy storage system 200 generally includes a surface fluid or hydraulic device 202 and a surface reservoir 205 (e.g., a pond) at the terranean surface 4 partially filled with saturated brine 201. In this exemplary embodiment, the storage chamber 50 is in fluid communication with the surface reservoir 205 via the wellbore 20. Particularly, hydraulic device 202 is connected between the surface reservoir 205 and wellbore 20 and is configured to communicate brine 201 between the surface reservoir 205 and storage chamber 50 located beneath the terranean surface 4. Hydraulic device 202 comprises one or more components for handling the brine 201 of energy storage system 200. For example, hydraulic device 202 comprises a fluid pump for pumping the brine 201. Hydraulic device 202 may also include an alternator where the fluid pump thereof may act as a fluid motor for powering the alternator to generate electrical energy.

In this exemplary embodiment, energy storage system 200 is configured to store energy hydraulically within the storage chamber 50. Particularly, fluid pressure within storage chamber 50 must generally be maintained above the formation pressure (contingent on the hydrostatic pressure and overburden pressure) but below the fracture pressure for the salt rock layer 8 to ensure the integrity of storage chamber 50. Without falling below the formation pressure or exceeding the fracture pressure, fluid pressure within storage chamber 50 may be cyclically increased and decreased to store and remove hydraulic potential energy from storage chamber 50.

By injecting fluid (e.g., saturated brine 201) into storage chamber 50 (e.g., via the operation of hydraulic device 202), fluid pressure within storage chamber 50 is increased resulting in the outward flexing (similar in nature to the compression of a spring or other biasing element) of relatively large disc-shaped roof 215 of storage chamber 50, thereby charging the storage chamber 50 with potential energy. In this exemplary embodiment, energy is supplied to the hydraulic device 202 from energy source 207 to power the hydraulic device 202 for pumping saturated brine 201 into the storage chamber 50 to increase the hydraulic potential energy stored therein.

Conversely, by releasing fluid (e.g., opening one or more valves of hydraulic device 202 to release saturated brine 201 from storage chamber 50) from storage chamber 50 the disc-shaped roof 215 of storage chamber 50 is permitted to return to its initial position releasing the spring-like potential energy stored in the storage chamber 50 (thereby discharging the stored potential energy from storage chamber 50) whereby fluid (e.g., saturated brine 201) is driven uphole through wellbore 20 and towards the surface reservoir 205.

In this exemplary embodiment, the brine 201 flowing uphole in the direction from storage chamber 50 and towards surface reservoir 205 powers the hydraulic device 202 (e.g., powers an alternator of the hydraulic device 202 driven by a hydraulic motor thereof) such that the hydraulic device 202 transfers energy (e.g., as electrical energy) to the energy source 207 where it may be consumed by end users. Thus, unlike conventional PHES systems which rely on differences in elevation (thus limiting such systems to relatively high-elevation applications), energy storage system 200 instead relies on the spring-like force exerted by the disc-shaped roof 215 of storage chamber 50 for storing hydraulic potential energy within the storage chamber 50 which may be selectably released as needed to translate the hydraulic potential energy into energy (e.g., electrical energy) that may be consumed by one or more end-users. Given that energy storage system 200 is not restricted to high-altitude locations, it may be provided on-site such as the location of a renewable energy generation system (e.g., a wind farm, a solar array) to conveniently store energy produced by the energy generation system as needed.

As an exemplary application of energy storage system 200, renewable energy such as wind or solar energy may define energy source 207 whereby the wind and/or solar energy may be used to pump saturated brine 201 downhill (rather than uphill like conventional PHES systems) away from the surface reservoir 205 and towards the storage chamber 50 during times of low energy demand. Conversely, when energy demand increases, or when renewable energy production is low, saturated brine 201 is released from the storage chamber 50 and permitted to flow uphill towards surface reservoir 205 and though hydraulic device 202 creating electricity.

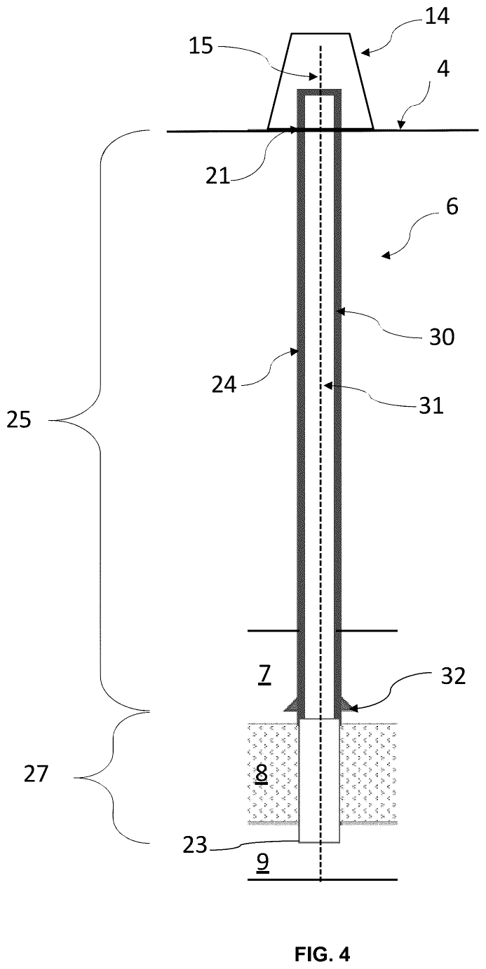

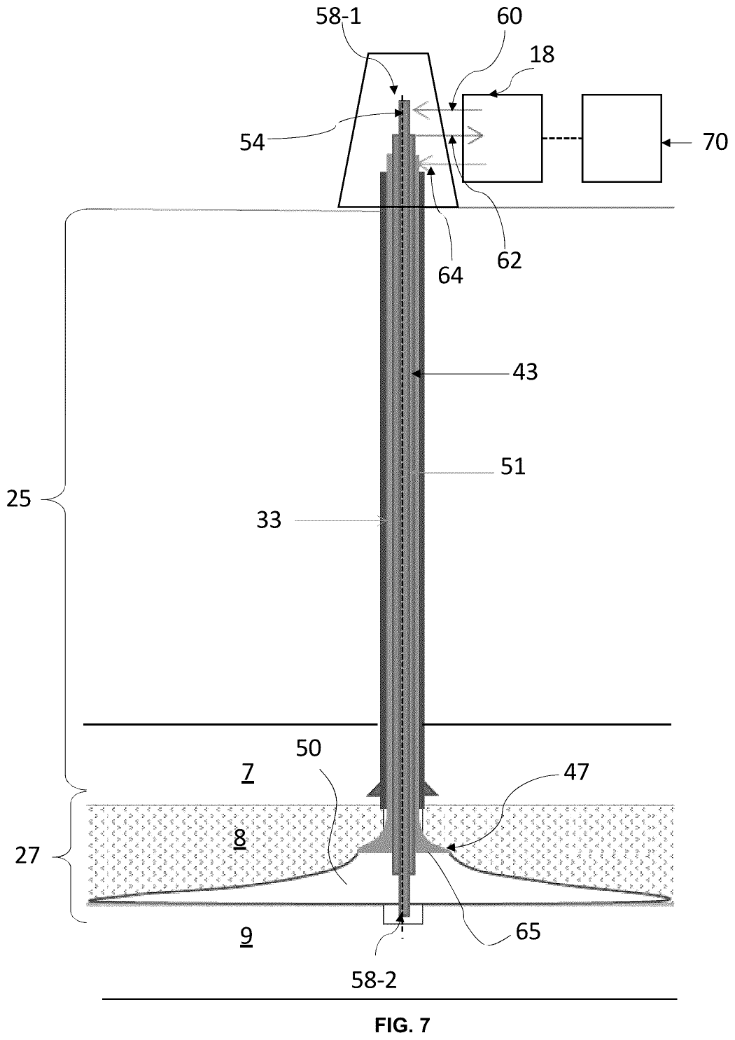

Referring now to FIGS. 4-7, having described embodiments of subterranean storage systems including subterranean storage chambers herein, an exemplary embodiment for forming a subterranean storage chamber (including a subterranean storage chamber having a thin form factor) will now be described. Particularly, and as shown particularly in FIG. 4, an exemplary method of forming a subterranean storage chamber (e.g., storage chamber 50 shown in FIGS. 1-3) initially includes forming a wellbore (e.g., wellbore 20) by drilling into the subterranean formation 6 from the terranean surface 4 using a drilling assembly (e.g., a drill bit coupled to a drill string suspended from the terranean surface 4). In an embodiment, the drilling assembly penetrates through the subterranean formation to form the wellbore 20 which extends vertically from uphole end 21, into the subterranean formation 6 along a central or longitudinal axis 15, and to a downhole end 23 located within subterranean formation 6.

In this exemplary embodiment, wellbore 20 is drilled such that wellbore 20 penetrates at least partially into the lower permeable rock layer 9 with the downhole end 23 of wellbore 20 located proximal (but vertically beneath) the interface formed between salt rock layer 8 and lower impermeable rock layer 9 of subterranean formation 6. In other embodiments, downhole end 23 may be located at the interface formed between layers 8 and 9, or proximal to (but vertically above) the interface formed between layers 8 and 9.

Additionally, as wellbore 20 is drilled using the drilling assembly, casing string 30 is gradually installed into the wellbore 20 and secured in place along the sidewall 24 of wellbore 20 against the sidewall 24 of wellbore 20 via cement (or any other suitable material) to prevent collapse of wellbore 20. In some embodiments, casing string 30 (which may comprise a plurality of cylindrical casing string joints connected end-to-end) is installed gradually as wellbore 20 is drilled by the drilling assembly. The casing string 30 extends from the terranean surface 4 to a downhole end defined by a bottom casing string shoe 32 that is located within the upper impermeable rock layer 7. Thus, in this exemplary embodiment, wellbore 20 is formed with a cased section 25 extending from the terranean surface 4 to casing string shoe 32, and an uncased or openhole section 27 extending from casing string shoe 32 to the downhole end 23 of wellbore 20. The cased section 25 is sealed from the subterranean formation 6 while the openhole section 27 is fluidically connected to the subterranean formation, including the salt rock layer 8.

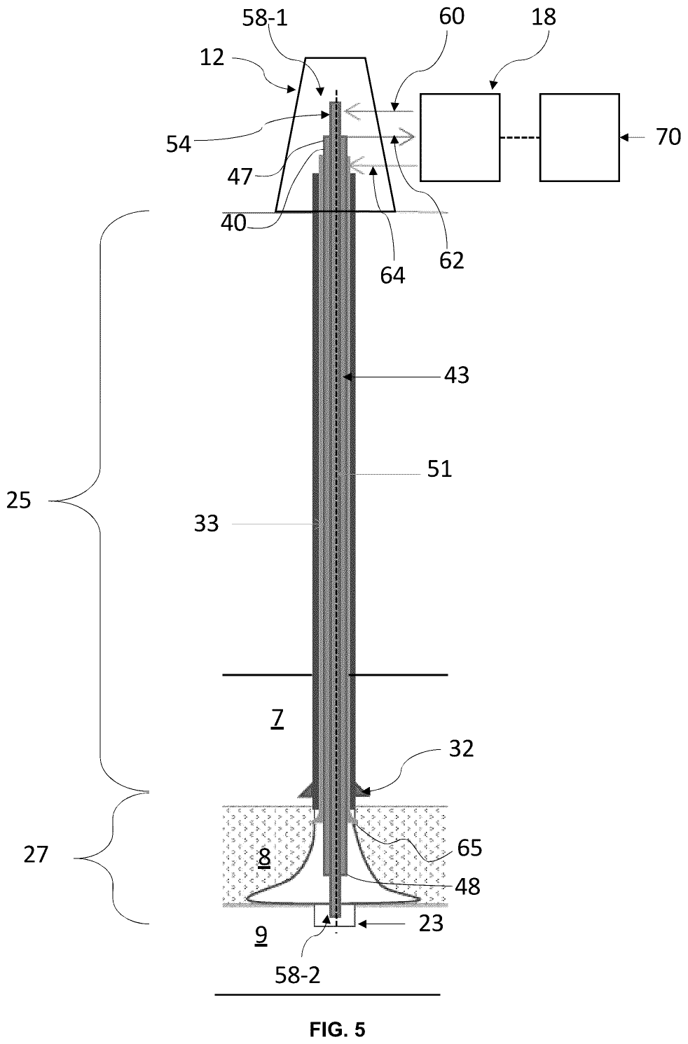

As shown particularly in FIG. 5, this exemplary method includes a depth-controlled washout of the salt rock layer 8 to create a subterranean storage chamber (e.g., storage chamber 50 shown in FIGS. 1-3). Particularly, a first or outer tubing 40 is installed within the central passage 31 of the casing string 30. Outer tubing 40 is positioned in the central passage 31 of the casing string 30 and extends axially from a first or uphole end 47 located at or proximate to terranean surface 4 (e.g. from surface equipment 12) to a second or downhole end 48 located within the salt rock layer 8 of subterranean formation 6. Outer tubing 40 may be centralized and secured in the central passage 31 of the casing string 30 via a first or outer tubing hanger coupled to the surface equipment 12. In addition, a second or inner tubing 54 is also installed in the wellbore 20 within a central passage of the outer tubing 40. Inner tubing 54, having a central passage 51, is positioned in the central passage of outer tubing 40 and extends axially from a first or uphole end 58-1 located at or proximate to terranean surface 4 to a second or downhole end 58-2 located proximal the downhole end 23 of wellbore 20. In this configuration, a first or outer annulus 33 is formed between the casing string 30 and outer tubing 40 while a second or inner annulus 43 is formed between outer tubing 40 and inner tubing 54.

After setting and cementing the casing string 30 in place, two different fluids may be injected into the wellbore 20 simultaneously. Particularly, three distinct flowpaths are formed between the surface equipment 12 located at the terranean surface 4 and the openhole section 27 of wellbore 20: (i) a first flowpath extends through the outer annulus 33 between surface equipment 12 and the openhole section 27; (ii) a second flowpath extends through the inner annulus 43 between surface equipment 12 and the openhole section 27; and (iii) a third flowpath extends through the central passage 51 of inner tubing 54 between surface equipment 12 and openhole section 27. It may be understood that in other embodiments the three flowpaths outlined above may be configured differently than the configuration shown in FIGS. 5-7. For example, in some embodiments, the three flowpaths may not be nested within each other as shown in FIGS. 5-7. For example, a first flowpath may be provided by a first fluid conduit while a second flowpath may be provided by a second fluid conduit where the first and second fluid conduits are not nested within one another.

Initially, in this exemplary embodiment, a predetermined volume of solvent 60 is injected from the terranean surface 4 into the wellbore 20 along the third flowpath extending through central passage 51 of inner tubing 54 such that that the solvent 60 is delivered to the openhole section 27 of wellbore 20 extending through the salt rock layer 8 of the subterranean formation 6. In this manner, the solvent 60 may be injected into the salt rock layer 8 whereby the injected solvent 60 dissolves rock salt forming the salt rock layer 8 forming a brine solution 62 within the openhole section 27 of wellbore 20. The brine 62 within the openhole section 27 of wellbore 20 is circulated to the terranean surface 4 along the second flowpath extending though the inner annulus 43 in response to injecting the solvent 60 into central passage 51 of inner tubing 54.

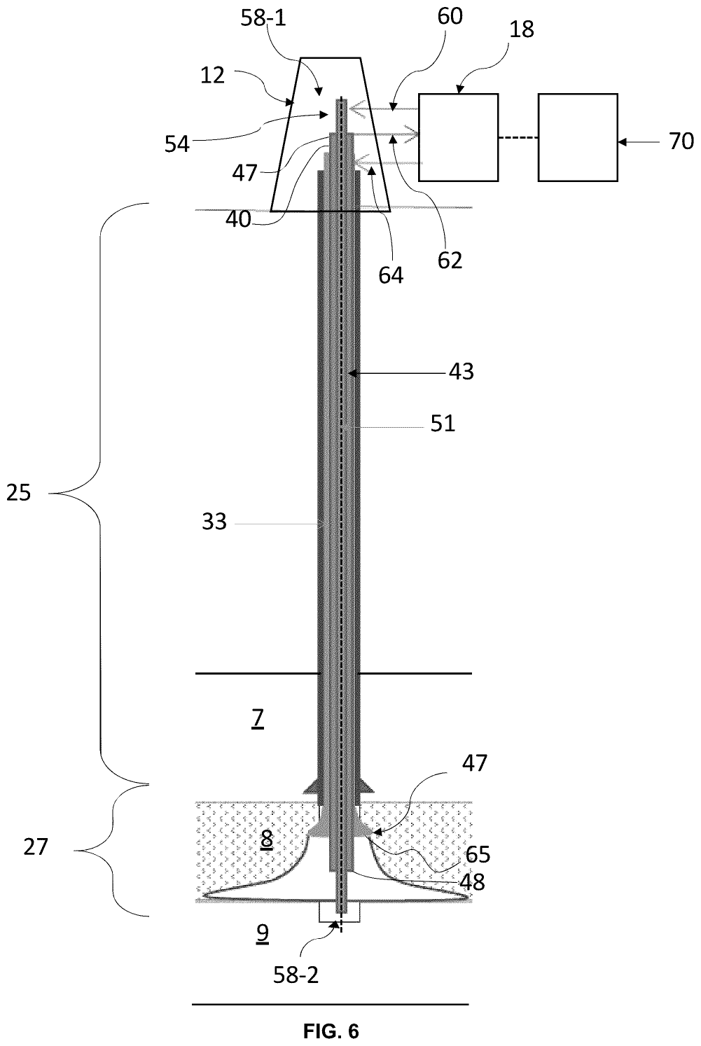

As shown particularly in FIGS. 5 and 6, in this exemplary embodiment, a protective fluid or blanket 64 (used interchangeably herein) is also delivered to the openhole section 27 of wellbore 20 along the first flowpath extending through the outer annulus 33. Protective fluid 64 forms a protective “blanket” or barrier along an interface 65 formed laterally between the protective fluid 64 and solvent 60 and/or brine 62 present within the openhole section 27 of wellbore 20. With interface 65 positioned downhole from casing string shoe 32 of casing string 30, protective fluid 64 may prevent contact between the solvent 60/brine 62, and the casing string 30 (including casing string shoe 32). In this exemplary embodiment, protective fluid 64 has a lower specific gravity than the solvent 60/brine 62 within openhole section 27 of wellbore 20, causing the protective fluid 64 to float above the brine 62 preventing contact between the solvent 60/brine 62 and the casing string 30 which could otherwise undesirably corrode casing string 30 in response to contact between casing string 30 and solvent 60/brine 62. In addition to having a lower specific gravity than solvent 60/brine 62, protective fluid 64 comprises one or more fluids configured not to react with or corrode the casing string 30 such as, for example, hydrocarbon or oil-based fluids.

In addition to protecting casing string 30 from solvent 60/brine 62, protective fluid 64 may be used to control the form factor of the resulting subterranean storage chamber formed from the continual removal of salt from the salt rock layer 8 by solvent 60. Particularly, in some embodiments, the difference in elevation between interface 65 and the lower impermeable rock layer 9 defines the vertical height of the resulting storage chamber (e.g., storage chamber 50) formed within salt rock layer 8. Thus, by controlling the volume of protective fluid 64, or a ratio of the volume of solvent 60 to the volume of protective fluid 64 injected into the wellbore 20, a predefined, desired form factor of the resulting storage chamber (e.g., a ratio of the vertical height of the storage chamber to a lateral width of the storage chamber) may be achieved, including thin form factors in which the storage chamber is formed as a generally thin, disc, or pancake shape. It should be appreciated that control of the wellbore 20 is maintained through surface equipment 12, and the ratio of solvent 60 and blanket 64 may be controlled by control system 70 positioned at the terranean surface 4.

Particularly, in this exemplary embodiment, the volume of solvent 60 and the volume of protective fluid 64 injected into the wellbore 20 is controlled automatically by a surface controller or control system 70 of subterranean storage system 10 that is communicatively coupled to surface equipment 12 such as surface pump 18.

It should be appreciated that control of the wellbore 20 is maintained through surface equipment 12, and the ratio of solvent 60 and blanket 64 may be controlled by control system 70 positioned at the terranean surface 4. The integrity of the storage system 10 can be maintained by filling wellbore 20 and storage chamber 50 with pressurized brine 62 such that fluid pressure within the openhole section 27 of wellbore 20 and within storage chamber 50 is maintained between their respective formation and fracture pressures.

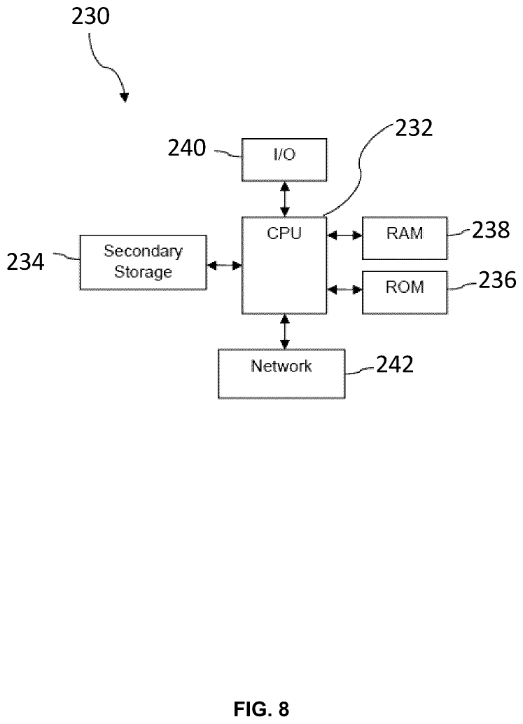

Referring now to FIG. 8, a computer system 230 suitable for implementing one or more embodiments disclosed herein. For example, the surface controller 70 described above may comprise the computer system 230 or at least some of the features of computer system 230. The computer system 230 includes a processor 232 (which may be referred to as a central processor unit or CPU) that is in communication with memory devices including secondary storage 234, read only memory (ROM) 236, random access memory (RAM) 238, input/output (I/O) devices 240, and network connectivity devices 242. The processor 232 may be implemented as one or more CPU chips. It is understood that by programming and/or loading executable instructions onto the computer system 230, at least one of the CPU 232, the RAM 238, and the ROM 236 are changed, transforming the computer system 230 in part into a particular machine or apparatus having the novel functionality taught by the present disclosure.

Additionally, after the computer system 230 is turned on or booted, the CPU 232 may execute a computer program or application. For example, the CPU 232 may execute software or firmware stored in the ROM 236 or stored in the RAM 238. In some cases, on boot and/or when the application is initiated, the CPU 232 may copy the application or portions of the application from the secondary storage 234 to the RAM 238 or to memory space within the CPU 232 itself, and the CPU 232 may then execute instructions that the application is comprised of. During execution, an application may load instructions into the CPU 232, for example, load some of the instructions of the application into a cache of the CPU 232. In some contexts, an application that is executed may be said to configure the CPU 232 to do something, e.g., to configure the CPU 232 to perform the function or functions promoted by the subject application. When the CPU 232 is configured in this way by the application, the CPU 232 becomes a specific purpose computer or a specific purpose machine.

Secondary storage 234 may be used to store programs which are loaded into RAM 238 when such programs are selected for execution. The ROM 236 is used to store instructions and perhaps data which are read during program execution. ROM 236 is a non-volatile memory device which typically has a small memory capacity relative to the larger memory capacity of secondary storage 234. The secondary storage 234, the RAM 238, and/or the ROM 236 may be referred to in some contexts as computer readable storage media and/or non-transitory computer readable media. I/O devices 240 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 242 may take the form of modems, modem banks, Ethernet cards, universal serial bus (USB) interface cards, wireless local area network (WLAN) cards, radio transceiver cards, and/or other well-known network devices. The network connectivity devices 242 may provide wired communication links and/or wireless communication links. These network connectivity devices 242 may enable the processor 232 to communicate with the Internet or one or more intranets. With such a network connection, it is contemplated that the processor 232 might receive information from the network, or might output information to the network.

The processor 232 executes instructions, codes, computer programs, scripts which it accesses from hard disk, optical disk, flash drive, ROM 236, RAM 238, or the network connectivity devices 242. While only one processor 232 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 234, for example, hard drives, optical disks, and/or other device, the ROM 236, and/or the RAM 238 may be referred to in some contexts as non-transitory instructions and/or non-transitory information.

In an embodiment, the computer system 230 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

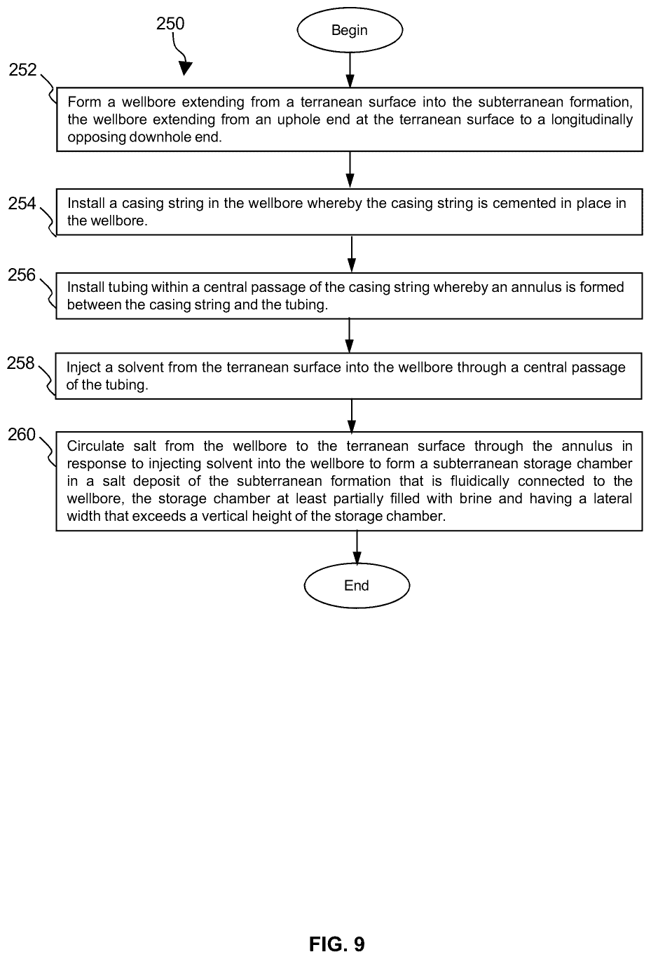

Referring now to FIG. 9, a flowchart of an embodiment of a method 250 for storing materials in an earthen subterranean formation (e.g., subterranean formation 6 shown in FIGS. 1-7) is shown. Beginning at block 252, method 250 includes forming a wellbore extending from a terranean surface into the subterranean formation, the wellbore extending from an uphole end at the terranean surface to a longitudinally opposing downhole end. At block 254, method 250 comprises installing a casing string in the wellbore whereby the casing string is cemented in place in the wellbore. At block 256, method 250 comprises installing tubing within a central passage of the casing string whereby an annulus is formed between the casing string and the tubing.

At block 258, method 250 comprises injecting a solvent from the terranean surface into the wellbore through a central passage of the tubing. In some embodiments, a blanket or protective fluid is also injected into the wellbore to protect the casing string from the injected solvent. At block 260, method 250 comprises circulating salt from the wellbore to the terranean surface through the annulus in response to injecting solvent into the wellbore to form a subterranean storage chamber in a salt deposit of the subterranean formation and fluidically connected to the wellbore, the storage chamber at least partially filled with brine and having a lateral width that exceeds a vertical height of the storage chamber.

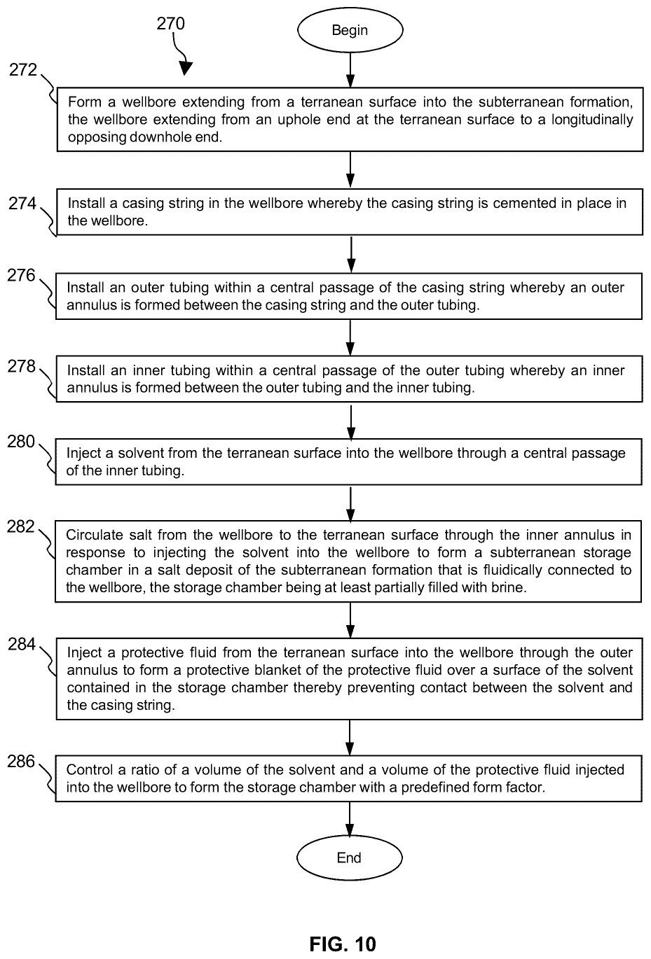

Referring now to FIG. 10, a flowchart of another embodiment of a method 270 for storing materials in an earthen subterranean formation (e.g., subterranean formation 6 shown in FIGS. 1-7) is shown. Beginning at block 272, method 270 includes forming a wellbore extending from a terranean surface into the subterranean formation, the wellbore extending from an uphole end at the terranean surface to a longitudinally opposing downhole end. At block 274, method 270 includes installing a casing string in the wellbore whereby the casing string is cemented in place in the wellbore. At block 276, method 270 includes installing an outer tubing within a central passage of the casing string whereby an outer annulus is formed between the casing string and the outer tubing.

At block 278, method 270 includes installing an inner tubing within a central passage of the outer tubing whereby an inner annulus is formed between the outer tubing and the inner tubing. At block 280, method 270 includes injecting a solvent from the terranean surface into the wellbore through a central passage of the inner tubing. At block 282, method 270 includes circulating salt from the wellbore to the terranean surface through the inner annulus in response to injecting the solvent into the wellbore to form a subterranean storage chamber in a salt deposit of the subterranean formation and fluidically connected to the wellbore, the storage chamber being at least partially filled with brine.

At block 284, method 270 includes injecting a protective fluid from the terranean surface into the wellbore through the outer annulus to form a protective blanket of the protective fluid over a surface of the solvent contained in the storage chamber thereby preventing contact between the solvent and the casing string. At block 286, method 270 includes controlling a ratio of a volume of the solvent and a volume of the protective fluid injected into the wellbore to form the storage chamber with a predefined form factor.

While disclosed embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A system for storing materials in an earthen subterranean formation, the system comprising:
a wellbore extending from a terranean surface into the subterranean formation, the wellbore extending from an uphole end at the terranean surface to a longitudinally opposing downhole end;
a casing string extending through the wellbore, wherein the casing string is cemented in place in the wellbore;
a subterranean storage chamber formed in a salt deposit of the subterranean formation and fluidically connected to the wellbore, the storage chamber at least partially filled with brine and having a lateral width that exceeds a vertical height of the storage chamber; and
wellbore-transportable foreign material that is stored in the storage chamber.

2. The system of claim 1, wherein a ratio of the lateral width of the storage chamber to the vertical height of the storage chamber is equal to or greater than 2:1.

3. The system of claim 1, wherein a ratio of the lateral width of the storage chamber to the vertical height of the storage chamber is equal to or greater than 4:1.

4. The system of claim 1, wherein a ratio of the lateral width of the storage chamber to the vertical height of the storage chamber is equal to or greater than 10:1.

5. The system of claim 1, wherein a ratio of a surface area to a volume of the storage chamber is equal to or greater than 5:1.

6. The system of claim 1, further comprising one or more storage containers positioned in the storage chamber, the one or more storage containers each comprising an inner cavity holding at least some of the stored material.

7. The system of claim 1, wherein the stored material comprises the brine at least partially filling the storage chamber.

8. The system of claim 1, wherein the stored material comprises hydrogen.

9. The system of claim 1, wherein the storage chamber comprises a single opening, the single opening fluidically connected to the wellbore.

10. The system of claim 1, wherein the stored material comprises radioactive waste material.

11. The system of claim 1, wherein the storage chamber is defined by a vertically lower floor formed from at least one of limestone, shale, and red rock of the subterranean formation.

12. A pumped hydroelectricity energy storage (PHES) system, the system comprising:
a first reservoir located along the terranean surface;
a second reservoir located at least partially within the storage chamber of claim 1, the second reservoir in fluid communication with the first reservoir; and
a pump fluidically connected to both the first reservoir and the second reservoir and configured to pump at least some of the brine into the second reservoir from the direction of the first reservoir.

13. A method for storing materials in an earthen subterranean formation, the method comprising:
(a) forming a wellbore extending vertically from a terranean surface into the subterranean formation, the wellbore extending from an uphole end at the terranean surface to a longitudinally opposing downhole end;
(b) installing a casing string in the wellbore whereby the casing string is cemented in place in the wellbore;
(c) installing tubing within a central passage of the casing string whereby an annulus is formed between the casing string and the tubing;
(d) injecting a solvent from the terranean surface into the wellbore through a central passage of the tubing; and
(e) circulating salt from the wellbore to the terranean surface through the annulus in response to (d) to form a subterranean storage chamber in a salt deposit of the subterranean formation that is fluidically connected to the wellbore, the storage chamber at least partially filled with brine and having a lateral width that exceeds a vertical height of the storage chamber.

14. The method of claim 13, further comprising:
(f) injecting a protective fluid from the terranean surface into the wellbore to form a protective blanket of the protective fluid over a surface of the solvent contained in the storage chamber thereby preventing contact between the solvent and the casing string.

15. The method of claim 14, wherein the protective fluid has a lower specific gravity than the solvent.

16. The method of claim 13, wherein a ratio of the lateral width of the storage chamber to the vertical height of the storage chamber is equal to or greater than 2:1.

17. The method of claim 13, wherein a ratio of a surface area to a volume of the storage chamber is equal to or greater than 5:1.

18. A method for storing materials in an earthen subterranean formation, the method comprising:
(a) forming a wellbore extending vertically from a terranean surface into the subterranean formation, the wellbore extending from an uphole end at the terranean surface to a longitudinally opposing downhole end;
(b) installing a casing string in the wellbore whereby the casing string is cemented in place in the wellbore;
(c) installing an outer tubing within a central passage of the casing string whereby an outer annulus is formed between the casing string and the outer tubing;
(d) installing an inner tubing within a central passage of the outer tubing whereby an inner annulus is formed between the outer tubing and the inner tubing;
(e) injecting a solvent from the terranean surface into the wellbore through a central passage of the inner tubing;
(f) circulating salt from the wellbore to the terranean surface through the inner annulus in response to (d) to form a subterranean storage chamber in a salt deposit of the subterranean formation that is fluidically connected to the wellbore, the storage chamber being at least partially filled with brine;
(g) injecting a protective fluid from the terranean surface into the wellbore through the outer annulus to form a protective blanket of the protective fluid over a surface of the solvent contained in the storage chamber thereby preventing contact between the brine and the casing string; and
(h) controlling a ratio of a volume of the solvent and a volume of the protective fluid injected into the wellbore to form the storage chamber with a predefined form factor.

19. The method of claim 18, wherein form factor of the storage chamber is defined by a lateral width and a vertical height, the lateral width exceeding the vertical height of the storage chamber.

20. The method of claim 19, wherein a ratio of the lateral width of the storage chamber to the vertical height of the storage chamber is equal to or greater than 2:1.

21. The method of claim 19, wherein (h) comprises:
(h1) decreasing the ratio of the volume of the solvent and the volume of the protective fluid to increase a lateral width of the storage chamber relative to a vertical height of the storage chamber.
